(19) United States
(12) Patent Application Publication
(10) Pub. No.: US 2010/0229821 A1
(43) Pub. Date: Sep. 16, 2010

(54) Plastic Structural Oil Sump with Fitted-on Bottom for a Combustion Engine and Method of Fabricating such a Sump

(75) Inventors: Laurent Decker, Vire (FR); Samuel Deschamps, Saint-Germain de Tallevende (FR)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: FILTRAUTO, Guyancourt (FR)

(21) Appl. No.: 12/404,009

(22) Filed: Mar. 13, 2009

(51) Int. Cl. F01M 11/00; F02F 7/00; B29C 45/00

(52) U.S. Cl. 123/195 C; 264/328.1

(57) ABSTRACT

Structural oil sump for a combustion engine, provided with a top opening and comprising:

a single-piece top part made of plastic material including a number of lateral walls peripherally delimiting an internal volume, and at least one transversal part extending inside said internal volume and joining at least two of the lateral walls, the top part extending between a top end defining said top opening and a bottom end defining a bottom opening;

a bottom part comprising a bottom and fixed in a sealed manner to the bottom end of the top part;

the sump being provided with internal ribs formed integrally with the top part and positioned opposite the bottom.

### FIELD OF THE INVENTION

The present invention relates to the field of oil sumps for internal combustion engines, typically placed at the bottom of the engine. The invention thus relates to a plastic oil pan/sump that is said to be structural, that is, that it supports dynamic bending and twisting forces (caused by the reactions of the engine mountings and of the gearbox of a vehicle). The invention also relates to the method of manufacturing this sump, and a use of a bottom part in an oil sump.

### BACKGROUND OF THE INVENTION

A combustion engine sump often has a structural role for the engine, when it is not made of thin steel plate. In a known manner, the sump comprises a pan or tank delimiting a volume for receiving oil on the one hand, and a top opening on the other hand. This top opening is edged by a flange joined to the pan, for mounting on a complementary member of a combustion engine. The engine sump thus adds rigidity in the cases where it forms a pan at the bottom of the engine or of the engine block because it has to withstand dynamic bending and twisting forces, caused by the reactions of the engine mountings and of the gearbox (to which it is also attached).

To address this issue of rigidity, it is known from the prior art, for the manufacture of oil sumps, to use molded metallic materials, such as cast iron or light alloys, ribbed in their design, supported by calculations and endurance tests. One drawback of these metallic materials used to obtain structural sumps is their weight. Furthermore, implementing them takes more energy. Their use gives an ecological budget that is therefore mediocre.

Known from document WO 03/102387 A1 is an oil pan for combustion engines, in which metal components are replaced by molded plastic components offering a rigidity comparable to that of the metal components. The pan comprises a molded plastic container on a metal or plastic support structure. An anti-turbulence or anti-emulsion plate can be inserted inside the pan and rest on appropriate mountings. Passages for the flow of oil are left around this plate.

This type of pan provides a way of addressing the two-fold issue of weight and rigidity. However, the overmolding manufacturing method is relatively complex to implement. The products obtained according to the teaching of document WO 03/102387 A1 are more costly to manufacture than a single-material sump, in particular made of injection molded plastic. A sump made up of a number of materials is also more difficult to recycle at the end of its life, because the components of different materials must be separated from one another, which components are moreover firmly linked to serve as reinforcements, particularly when these reinforcements have been overmolded.

It is also necessary to stress here the fact that, hitherto, the use of injected plastic to manufacture a sump has been limited to a very small number of applications, when the stresses exerted on the bottom of the engine are relatively weak. For more severe applications, the forces (bending, twisting, stresses exerted on the plastic walls) are too great and the sump must be designed using metal material. There is therefore a need for sumps mainly or completely produced using plastic material and offering good structural characteristics.

### SUMMARY OF THE PRESENT INVENTION

The aim of the present invention is therefore to eliminate one or more of the drawbacks of the prior art by defining a sump of light weight and of simplified design, and therefore less costly, which offers good structural resistance characteristics.

To this end, there is proposed according to the invention a structural oil sump for a combustion engine, provided with a top opening and comprising:

a single-piece top part made of plastic material comprising a number of lateral walls peripherally delimiting an internal volume, and at least one transversal part extending inside said internal volume and joining at least two of the lateral walls, the top part extending between a top end defining said top opening and a bottom end defining a bottom opening;

a bottom part comprising a bottom and fixed in a sealed manner to the bottom end of the top part;

the sump being provided with internal ribs formed integrally with the top part and positioned opposite the bottom.

Thus, the sump is obtained by the joining of two parts, at least the top part being able to be light (this top part also being simple to mould). The bridge formed by the transversal part which is firmly linked to the lateral walls makes it possible, with the internal ribs, to increase the rigidity and consolidate the structure of the sump. The priority function of this plastic bridge is a structural function, unlike the anti-emulsion plates whose main function is to allow for a circulation of the oil.

In various embodiments of the structural oil sump according to the invention, one or more of the following arrangements may, if necessary, be used:

the bottom part is made of plastic material;

the transversal part is further away from said bottom than from the top end of the top part;

the transversal part is further away from the bottom end than from the top end of the top part;

the internal ribs comprise ribs integrally linked both to one of the lateral walls and to said transversal part;

the transversal part forms a bridge provided with orifices distant from the lateral walls to allow a circulation of oil.

the top part has an inverted U shape, respectively according to two mutually orthogonal vertical cross-sectional planes;

the bottom part offers an internal volume of which a portion has a section, perpendicularly to the heightwise direction of extension of the top part, greater than the section of the internal volume of the top part (the heightwise direction of extension of the top part is typically also the direction of demolding of this part);

the bottom part is essentially made of plastic material and is secured by welding to the bottom end of the top part;

the welding extends continuously all around the bottom opening;

the sump also comprises a securing device for securing the bottom part to the top part;

the bottom part comprises, on at least one external face, one or more projecting fixing members formed with the bottom part;

the bottom part comprises a cavity for incorporating an oil treatment module in a housing situated inside the bulk volume delimited by the sump.

Moreover, another subject of the invention is a manufacturing method that is relatively simple and easy to industrialize that makes it possible to obtain a sump that is both lightweight and highly structural.

To this end, there is proposed a method of manufacturing a structural oil sump for a combustion engine, comprising a step for assembling two complementary parts, of which one is a bottom part comprising a bottom and the other a top part comprising a top end delimiting a first opening of the top part, characterized in that:

a molding is produced by injecting plastic material to provide, all in a single block, said top part with an integrated transversal part which extends inside an internal volume of the top part;

during the injection molding, there is formed, integrally with the transversal part, ribs projecting towards a second opening of the top part; and

during the assembly step, the bottom part is fixed to the bottom end of the top part, at a distance from the transversal part, to block off said second opening in a sealed manner.

Thanks to the present invention, it is possible to minimize the impact, on the cost of the manufacturing method, of changes made to an oil sump mainly made of plastic. It is thus possible to use a bottom part to form a part of a structural oil sump according to the invention, this bottom part being used in a method of closing said sump from the bottom. It is thus advantageously possible to easily and inexpensively have the shape of the sump changed, by modifying only the bottom part. Modifications do not relate to the top part which comprises the reinforcing ribs. Thanks to the flexibility of the design of the injected plastic shapes, it is possible to produce undercuts, pipe overmoldings, plastic welds, sometimes even an adhesive bonding.

### BRIEF DESCRIPTION OF THE DRAWINGS

Other features and benefits of the present invention will become more clearly apparent from reading the description herein below, given with reference to the appended drawings in which:

FIGS. 1A and 1B represent perspective views of a sump according to one embodiment of the invention, respectively with dissociation and association of the constituent parts;

FIG. 2 represents in perspective the underside of the top part of the sump illustrated in FIG. 1A;

FIGS. 3A, 3B and 3C show respective cross-sectional views which illustrate typical layouts of a sump according to the invention at the bottom of a combustion engine;

FIGS. 4A and 4B represent in cross-section respective exemplary seal-tight links between the constituent parts of a sump according to the present invention;

FIGS. 5A and 5B schematically show respective exemplary forms for a sump according to the invention;

FIG. 6 represents a bottom view of a sump according to a variant embodiment of the invention.

### DETAILED DESCRIPTION OF THE INVENTION

In the various figures, the same references designate identical or similar elements.

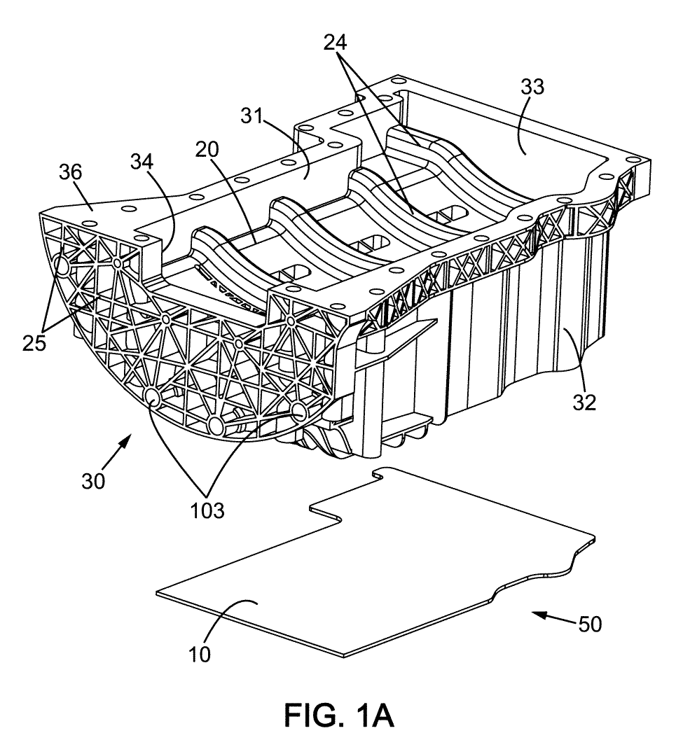

The oil sump for a combustion engine will now be described in association with FIGS. 1A, 1B, 2 and 6.

The structural oil sump 100 is formed by an assembly of two complementary parts of which one, the bottom part, comprises a bottom 10 of the sump 100 and the other, the top part, is a superimposed part provided with reinforcing ribs 24, 25. The two complementary parts are preferably made of plastic. Alternatively, the bottom part can be made of lightweight material other than plastic.

In a preferred embodiment, the plastic material used is, for example, a thermoplastic withstanding temperatures of the order of 100° C. and above. In a non-limiting manner, at least the top part of the sump 100 is based on polyamide. Plastic PA6.6GF35 can be used for the design of the parts of the sump 100. The temperatures accepted continually by such plastic materials such as PA6.6GF35 have reached those of alloys (as an indication, the mechanical properties of aluminum alloys drop away towards 150° C.).

The top part 30 consists of a multiple-walled single-piece part comprising lateral walls 31, 32, 33, 34 (typically at least four lateral walls), and at least one transversal part 20 linking at least two of the lateral walls 31, 32, 33, 34 to form a bridge. The lateral walls for example form a peripheral part 31, 32, 33, 34 which surrounds the transversal part 20. This transversal part 20 can consist of a plate. It can also form a wall extending inside the internal volume substantially transversally to the heightwise direction of extension of the top part 30. The distance separating the transversal part 20 from the top end of the top part is less (for example at least four times less) than the distance separating the transversal part 20 from the bottom end of the top part 30.

A seal-tight link 40 is produced between the bottom part 50 comprising the bottom 10 and the top part 30. The resulting assembly forms a sump 100 which is provided with internal ribs 26, 27 that are raised and opposite the bottom 10.

The sump 100 comprises at its top end a flange 36 which can be formed by a collar, continuous or otherwise, of the single-piece part 30. The flange 36 can extend laterally towards the outside relative to the top edge of the lateral walls 31, 32, 33, 34 of the single-piece part 30. This flange 36 delimits a top opening of the sump 100. The flange 36 constitutes a member by which the sump 100 can be attached, for example to an engine cylinder block 120. Holes 35 with vertical component are, for example, distributed over the flange 36 to provide the link to the bottom of the block 120. It will be understood in light of FIGS. 1A and 1B that the single-piece top part 30 does not include crankshaft bearings or bearing mountings (sources of stresses) but can be fixed to the bottom of the engine (directly to the bottom of the cylinder block 120 or indirectly, for example via a soleplate). The mounting on one or more complementary members of the combustion engine or cylinder block 120 of a motor vehicle can be done conventionally. The flange 36 delimits an opening for accessing the sump 100, through which opening oil can be poured onto the bottom 10.

Referring to FIGS. 1A and 1B, the constituent parts 30, 50 of the oil sump 100 are assembled together. The bottom part 50 can be flattened and form a base and, more generally, can define the bottom 10 where a volume of oil (oil reserve) can rest. The top part 30 is obtained by injection. In a preferred embodiment, the top part 30 has four lateral walls 31, 32, 33, 34 on the one hand, that can constitute all or part of the lateral periphery of the sump 100, and at least one transversal plate on the other hand, joining two opposite walls of the top part 30 and, possibly, other lateral walls. The transversal part 20 forms a partition or a non-removable top wall delimiting a bottom volume of the sump 100. The oil reserve volume, from which a pumping system that is known per se can typically draw, can occupy a portion of this bottom volume. In different embodiments, the bottom part 50 can form a portion of the base of the sump. Different forms are adapted for this part 50: the latter can be, for example, flat, incurved or provided with reliefs.

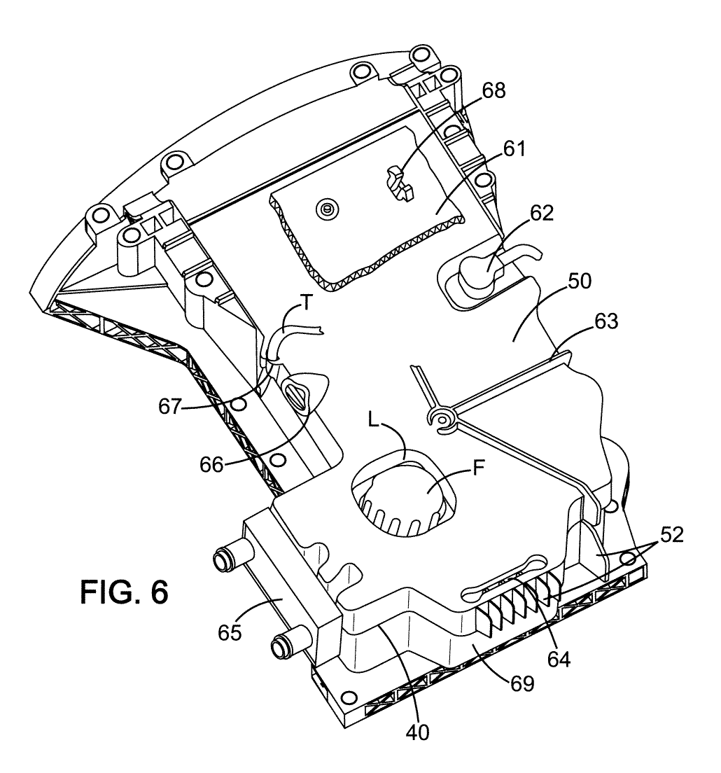

The bottom part 50 can also delimit cavities. Referring to FIG. 6, a housing L can thus be defined by a cavity formed in the bottom surface of the part 50. The bottom part 50 is thus adapted to support, for example, an oil circulation and/or treatment module F. This type of housing L makes it possible to incorporate the module F inside the bulk volume delimited by the sump 100. The bottom part 50 can support functional members or projecting fixing members 67, 68. By way of example, it is thus possible to connect all or part of the oil strainer pipe, a part of the ducting, all or part of the housing for an oil filter, all or part of an oil cooling system. An oil pump can also be supported. The bottom part 50 can also support forms facilitating the flow of the oil or protecting the draining operator from oil splashes. In other embodiments, the bottom part 50 can support fewer, even no elements and the dimensions of the part 50 can be less than those of the lateral contour of the sump 100. In this case, it is the top part 30 that can support most of the elements mentioned above or illustrated in FIG. 6.

In the example of FIG. 6, the bottom part 50 comprises at least one fixing member 68 making it possible to support an acoustic absorption or attenuation coating 61. This coating 61 is, for example, stuck to the underside of the part 50. Acoustic ribs 63, several of which converge towards one and the same area, can be provided on the underside of the bottom part 50. Shock absorption ribs 52 are, for example, present, at least in a peripheral area of the bottom part 50.

One or more fixing members 67 for a pipe T can also be provided. A draining system 66, for example in the form of an interface for connecting to a drainpipe, can also be formed on the bottom part 50. Forms facilitating the flow of the oil to the draining plug can also be provided on the bottom part 50. Alternatively, the drain hole can be made in a bottom portion of the top part 30. A sensor 62 and/or an oil level gauge can be fixed to the bottom part 50. In the example of FIG. 6, and for practical reasons, the bottom part 50 comprises a bottom surface and lateral walls extending the bottom 10 heightwise. This facilitates the incorporation of functions such as the pipes for sucking oil (and its strainer) towards a filter or the circulation of cooling water towards a heat exchanger. The bottom part 50 can then have the general form, in vertical section, of a U with the opening at the top. As illustrated in FIG. 6, the part 50 can in this case laterally support fixing members 67, an oil cooling system 65 and other supports. The form of the bottom part 50 is therefore not fixed and is typically adapted to constraints of bulk, and the height, the length and/or the width of this part 50 can be adjusted accordingly.

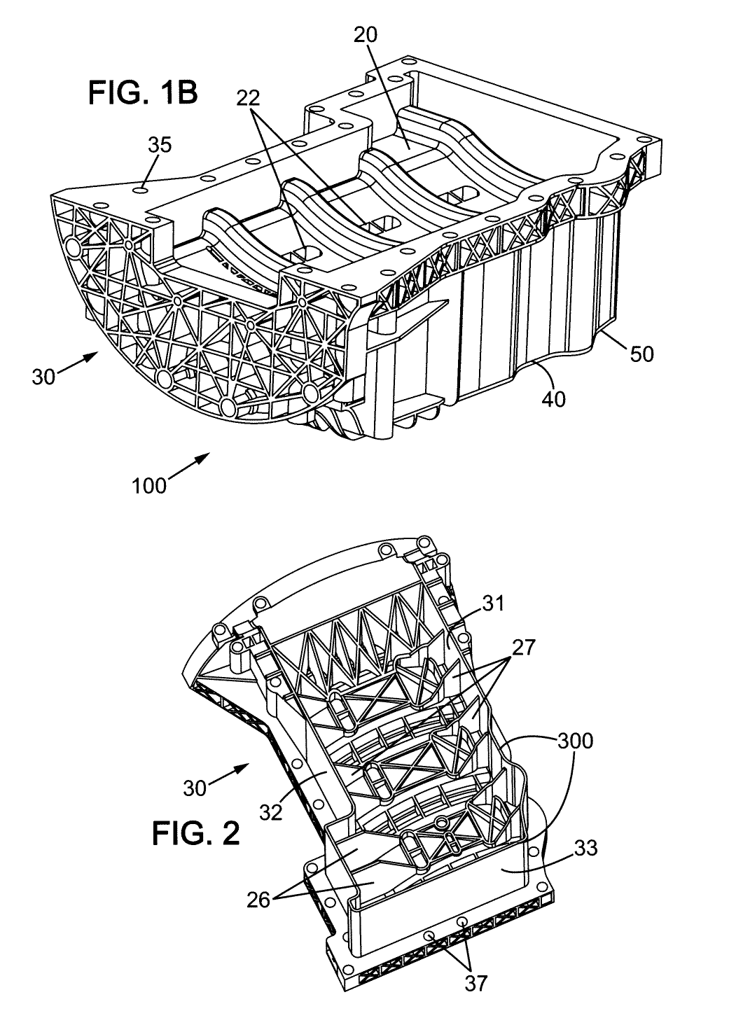

As an example, the sump height can be minimized and a volume surplus 69 can be added at the bottom of the sump 100, as illustrated in FIG. 6. It is possible to provide, in the additional volume area, one or more wells 64 for accessing the fixing members 37 (FIG. 2) provided at the level of the flange 36 for attachment to the bottom of the cylinder block 120. It will thus be understood that this bottom part 50 can advantageously serve as a version plate, that is, it can change, for one and the same engine, from one vehicle application to another (other U-section, with the vertical branches higher, other lateral oil volumes, form to avoid a close accessory or support a new or a different one, and so on). In this case, the top part 30 forming the main part of the sump 100, for example, does not vary (or varies only by the mounting or non-mounting of accessories), and only the bottom part 50 for closure by the bottom, which is more cost-effective, is adapted to the vehicle application.

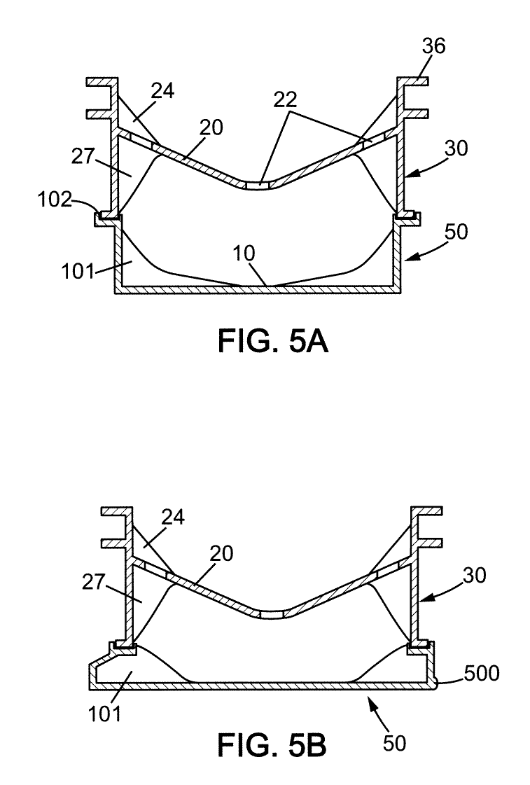

FIGS. 5A and 5B illustrate exemplary sumps 100 with variable forms for the bottom part 50. In particular, a height saving is obtained by using the bottom part 50 shown in FIG. 5B. To obtain this height saving, at least one external lateral widening or expansion 500 is provided making it possible to increase the internal volume at the level of the base of the sump 100. The bottom part 50 can thus offer an internal volume portion which, perpendicularly to the direction of extension, has a section greater than that of the internal volume of the top part 30. The structure of the bottom part 50 is consolidated by internal ribs 101 formed either side of a median or intermediary vertical plane of the bottom part 50, and extending on the bottom towards the inside of the sump. Preferably, there is no separation of the oil volume caused by these ribs 101.

Two external lateral widenings or expansions 500 can be provided, as illustrated in FIG. 5B. It is possible to have at the level of these lateral expansions one or more wells making it possible to vertically screw the sump 100 onto the bottom of the engine, through the additional volume. Each well can combine a number of screw spot facings to enhance its withstand strength, in particular during an operation to weld the two parts 30, 50 of the sump 100. The excrescences formed by these expansions 500 extend outside the naturally demoldable volume. In this case, movements are generated at the moment of demolding of the bottom part 50, using appropriate tools.

In the non-limiting example of FIGS. 1A and 1B, the internal surfaces of the lateral walls 31, 32, 33, 34 and the bottom 10 of the bottom part 50 define a hollow interior. The sump thus defines a pan provided with a reinforcing bridge formed by one or more transversal plates 20. The lateral walls 31, 32, 33, 34 extend in a generally vertical direction from the bottom 10. A seal-tight link 40 is made at the level of these lateral walls 31, 32, 33, 34 to connect the bottom part 50 and the multiple-wall top part 30.

The multiple-wall top part 30 is therefore designed without a bottom. The result of this is ease of demolding: it is therefore easy to produce, on each side of the plastic transversal portion 20, ribs 24, 26, 27 joining lateral walls of the sump 100. In other words, the ribs 24, 26, 27 that are produced are integrally linked both to one of the lateral walls of the top part 30 and to said transversal part 20. Certain ribs 26, 27 formed on the underside of the transversal part 20 can extend downwards over a height representing at least half of the height of the volume delimited at the bottom of the sump by the transversal part 20.

As illustrated in FIG. 2, respective ribs 27 that are mutually identical can be positioned widthwise, either side of a longitudinal median plane of the sump 100. Moreover, ribs 26 are provided which extend, for example, to the bottom of the lateral walls 31, 32, 34 of the top part 30. A number of parallel ribs 26, 27 can thus be formed on the underside of the transversal part 20 and project towards the bottom 10 of the sump 100. Convergent ribs are also provided facing the bottom 10. It will be understood that this type of rib makes it possible not to reduce the oil volume that can actually be used for the operation of the engine because they do not form separations of the oil volume. Thus, the risks of using the oil more quickly are limited. The downward ribs 26, 27 can also be narrower at their bottom end. These internal ribs 26, 27 are preferably raised relative to the bottom 10. At least the largest ribs 26, formed from the top part 30, can descend to a distance less than approximately 5 cm from the bottom 10 and penetrate into the oil. At this point, they do not hamper the flow of the oil coming from the engine or returning thereto. These ribs 26 make it possible, on the contrary, to calm this fluid, by delaying its movements during accelerations.

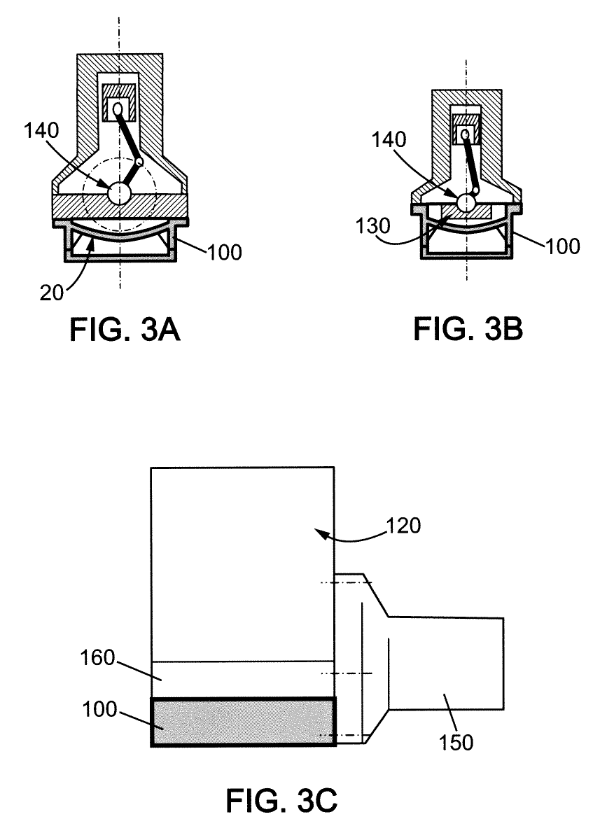

Referring to FIGS. 3A, 3B and 3C, conventional methods of connecting an oil sump 100 in accordance with the invention are shown. These connection methods and any other appropriate method can be applied for a sump 100 in accordance with the invention. As can be devised by those skilled in the art, the sump 100 makes it possible to enclose from the bottom the empty space or spaces formed in the cylinder block 120 of the engine. The sump 100 does not generally exceed the height level of the crankshaft 140. The bearing caps 130 of the camshafts constitute one of the bottommost portions of the cylinder block 120, these bearing caps 130 being able to be inserted into the bulk volume of the sump 100. A metal closure soleplate 160 can also be used to connect the oil sump 100, as illustrated in FIG. 3C. An external face of the sump 100 can also offer fixing members for a gearbox 150. The sump 100 can also accommodate a reinforcing part extending from the bottom of the cylinder block to the gearbox 150.

An anti-emulsion plate (windage tray or baffle plate) can sometimes be included underneath the crankshaft 140, in a position, for example, higher than that of the transversal part 20. This type of plate does not adequately reinforce the inertia of the sump because it is not strongly linked to the lateral walls 31, 32, 33, 34 and is in contact with the latter only over an area that is reduced in height. To be truly structural, a sump 100 in accordance with the invention has at least one transversal part (plate, wall or similar element) integrally formed with the peripheral part of the top part 30. Naturally, an anti-emulsion plate can, if necessary, be directly attached to the top part 30.

In the example of FIGS. 1A and 1B, orifices 103 are provided in a wall 34 of the peripheral portion of the top part 30. In a non-limiting manner, the orifices 103 can receive screws or pins or nuts mounted, crimped or overmolded with plastic, or pin studs. These orifices 103 provide the link with the gearbox 150. In one embodiment, the wells of plastic material formed at the level of each of the orifices 103 can be internally reinforced by a tubular sleeve in a material of greater rigidity. A metal material can typically be used, so that the sleeve limits or prevents deformations of the associated well. More generally, fixing members, preferably rigid, can be provided in the bottom part 50 and/or the top part 30, on a side to enable an external surface of the sump 100 to be connected to the gearbox 150.

As illustrated in FIG. 1A, the top part 30 made of plastic material can extend between a top end making it possible to delimit the top opening of the sump 100 and a bottom edge 300 that can rest on the bottom 10 of the oil sump 100, the bottom part 50 being flattened. In this case, the top part 30 extends over almost the entire height of the sump 100. The benefit of providing the single-piece part 30 with a transversal part 20 is to very greatly improve the response capability with respect to stresses on the structure of the sump 100. Indeed, with simple lateral walls of plastic material, of great height and smooth, lateral stresses exerted towards the hollow interior can very quickly lead to wall deformations, all the more so if the thickness is small.

With the transversal portion 20 formed integrally with the lateral walls 31, 32, 33, 34, such deformations are prevented. The transversal portion 20 is also provided with ribs 24, 26, 27 integral both to the transversal part 20 and to one of the lateral walls 31, 32, 33, 34 of the single-piece part 30. These ribs 24, 26, 27 provide reinforcement, and it is possible to retain a small thickness and so lighten the sump 100. The structural effectiveness obtained in this way is far greater than the use of a simple fitted-on adjoining plate. Moreover, the provision of the internal ribs 26, 27 does not cause any bulk problem for the sump 100. There is no need to provide ribs that project too much around the sump 100.

The benefit of providing a reinforcement in the form of a transversal part 20 and the associated ribs 24, 26, 27 is to improve the mechanical behavior of the sump 100, without requiring too great a wall thickness. The manufacturing of sumps with walls 5 mm or more thick is thus avoided. The top part 30 made of injected plastic, unlike parts with too great a thickness, can then easily be manufactured in series. A considerable time saving is obtained for the manufacturing cycles. Furthermore, the architecture of the top part 30 allows for demolding without difficulty, and notably without risk of deformation on removal from the mould.

The sump 100 represented in FIG. 1 B forms a container accessible from the top. By closing the hollow interior, as can be seen in FIG. 2, six strongly linked faces make it possible to considerably increase the inertia of the duly constituted sump 100, given equal bulk. The inertia is also increased by the internal ribs 26, 27, which can be seen in FIG. 2. The transversal part 20 therefore forms a bridge covering the hollow interior and provided with orifices 22 for the oil to pass through. These orifices 22 are preferably distant from the lateral walls 31, 32, 33, 34, so as not to lower the inertia of the sump 100.

In one embodiment of the invention, the transversal part 20 is positioned approximately at mid-height or a little higher, and, by itself, increases the rigidity of the link between the gearbox 150 and the cylinder block 120. In the example of FIGS. 1A and 1B, the transversal part 20 extends from the middle of the wall 33 opposite to the gearbox 150, to the middle of the wall 34 forming the contact between the box 150 and the sump 100. The section of the transversal part 20 is configured to withstand the twisting forces that are relatively parallel to the rotation axis of the engine (longitudinal axis for the sump 100). Obviously, regardless of its form, the transversal part 20 must not hamper the circulation of the oil cascading from the block, or its return via the suction pipe.

The multiple-walled single-piece part 30 can be made by a controlled injection of plastic material into a mould, through one or more injection points, so as to obtain one and the same thickness for the transversal part 20 and for the lateral walls 30, 31, 32, 33. In the example of FIGS. 1A, 1B, 2, 5A and 5B, the top part 30 has an H section in at least one vertical cross-sectional plane. The bottom part 50 complements the base of the H and makes it possible to delimit the hollow interior at the bottom of the sump 100. The mould used to manufacture the single-piece part 30 receives a thermoplastic material up to a top delimitation, the border of which is substantially the same as the border of the bottom part 50.

In one embodiment of the invention, the multiple-walled single-piece part 30 can be in the form of a U, inverted, in respectively two mutually orthogonal vertical cross-sectional planes. The multiple-walled top part 30 can also be in the form of an H in respectively two mutually orthogonal vertical cross-sectional planes.

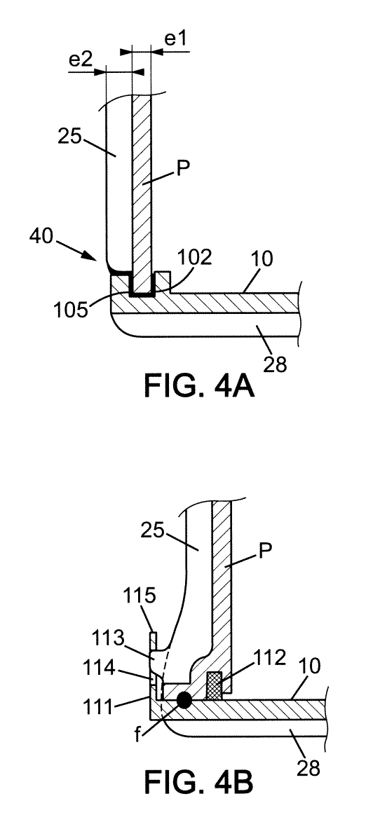

In the example of FIGS. 1A and 1B, 4A and 4B, the seal-tight link 40 is produced at the base of the sump 100, on a plate forming the bottom 10. The bottom part forming the bottom 10 is, for example, welded over an entire periphery with a bottom edge 300 of the top part 30, in a seal-tight manner by an appropriate technique such as welding by mechanical vibration, by ultrasound or by laser. In the examples of FIGS. 5A and 5B, the seal-tight link 40 is also produced at a distance from the transversal part 20, but at a level that is raised relative to the base of the sump 100. The part 30 can be fitted into an accommodating peripheral portion of the part 50.

Referring to FIG. 4A, the plastic can thus be melted in a contact area 105 between the lateral walls 31, 32, 33, 34 of the top part 30 and the bottom part 50. A hollow molding 102 can be provided on a top edge of the part 50 to receive the bottom of a corresponding wall P of the top part. The wall P is thus countersunk into the hollow molding 102. The molding 102 is, for example, made over a continuous periphery of the top edge. One or more ribs 25 formed on the outside of the wall P can also be fused, by their bottom end, with the outside of the top edge of the part 50 forming the bottom. The wall P that is illustrated is vertical but could also be angled and/or be prolonged in a direction with mostly horizontal component, according to less preferable variant embodiments.

The seal-tight link 40 can therefore be obtained by a continuous weld. In the example of FIG. 4A, the seal-tight link 40 extends both through the thickness e1 of the wall P and the excess thickness e2 added by the external ribs 25. The seal-tight link 40 involves not only the bottom termination of the wall P but also of the adjacent lateral areas in contact with the interior of the molding 102. There will also be noted in the exemplary embodiment of FIGS. 4A and 4B ribs 28 formed on the underside of the bottom part 50.

Referring to FIG. 4B, at least one seal 112 can be used in the seal-tight link 40. As an example, the seal 112 can consist of a seal-tight ring that is placed on the top part 30 taken from the mould, in a hollow molding formed at the end of the part 30 on the side by which it is taken from the mould.

It is then possible to position the bottom part 50 so as to cover the seal-tight ring and produce the joining of the two constituent parts 30, 50 of the sump 100. The sump 100 can be assembled with the multiple-walled single-piece top part 30 turned over relative to the position illustrated in FIGS. 1A and 1B. Alternatively, the assembly can be produced in the manner illustrated in FIG. 4B, with the multiple-walled part 30 placed in position after its removal from the mould.

The two complementary parts 30, 50 are preferably made of the same plastic, which makes it possible to produce a plastic weld and obtain a single-material sump. To allow for laser welding, one and/or the other of the two parts 30, 50 is made of a material transparent to laser emissions. In the example of FIG. 4B, the fusion area or areas f can be less wide compared to that illustrated in FIG. 4A. It is possible to provide discontinuous fusion areas f or just a single peripheral fusion area. Clipping or screwing (or any other appropriate fixing) can be done prior to the welding so as to ensure the correct positioning of the parts 30, 50 relative to each other. When an elastic seal 112 is used to ensure the seal-tightness, such clipping or screwing can be used to compress this seal 112. One or more snap-fitting pawls 113 can be used, for example, to retain the free end 115 of an element 111 covering said pawl, to hold together the bottom part 50 and the top part 30.

Clipping the bottom part 50 makes it possible to hold this part 50 against the lateral walls 31, 32, 33, 34 of the top part 30. The holding action is obtained when the clips 113 are engaged with a complementary part. To take a by no means limiting exemplary embodiment in which the clips 113 are molded with the multiple-walled single-piece part 30 (case of FIG. 4B), the complementary part can be an openwork area 114 or a female member positioned in a collar 111 or similar covering element(s) of the bottom part 50. When the clips 113 are engaged, a stress position of the bottom part 50 against the top part 30 is obtained, because of the traction exerted by the clips 113 on the end portion 115 of the part 50 (pulling upwards in the case of FIG. 4B). According to one embodiment of the method of manufacturing the sump 100, the clips 113 are laterally distributed over the periphery of one or other of the parts 30, 50, so as to link said bottom 50 and top 30 parts in a completely seal-tight manner. The welding operation can, if necessary, be eliminated if the seal-tightness and a good mechanical strength of the structure are obtained via the clipping or even screwing. In one embodiment, the bottom part 50 can be fixed in a seal-tight and removable manner to the top part 30. Unclipping using appropriate tools is, for example, used to allow the seal-tight link 40 to be broken and the parts 30, 50 to be separated.

The method of manufacturing the oil sump 100 can include two steps of injection into a mould to obtain respectively the top part 30 and the bottom part 50, then a step of assembly of these two parts 30, 50. The injection steps are easy to implement. The multiple-walled top part 30 illustrated in FIG. 1A typically weighs several kilograms on leaving the mould. To inject such a quantity of plastic in a short cycle time and retain the dimensional characteristics that are necessary to the assembly of the constituents and the functions of the finished part, several injection points or expanses are preferably required. The practice of controlled injection, for example of the sequential type, gives good adjustment flexibility. Thus, several injection points will preferably be provided for at least one of the two bottom and top parts 30, 50.

One of the benefits of the sump based on plastic material, in particular thermoplastic(s), is the natural ability for this sump 100 to absorb acoustic waves. Now, for environmental reasons, efforts are being made to reduce the vehicle passing noise, largely generated by the reflection of the acoustic waves originating from the engine on the road. Under-engine screens are no longer adequate to attenuate this energy, which is propagated towards the bottom of the engine, through the sump. The sump 100, consisting, for example, entirely of thermoplastic, can itself attenuate emitted noise of several dBA, in the audible frequency. Consequently, it makes it possible, in this large measure, to avoid having to use an additional absorption part which is costly, weighty, bulky and a hindrance to maintenance.

One of the benefits of the method is to give the possibility of ribbing the sump from a high position corresponding to the position of the transversal plate 20 towards the outside, in particular towards the bottom, with a rib height that is advantageous, because it is essential to minimize the height of the structural sump 100 to preserve the ground clearance of the vehicle and not reduce the necessary oil capacity. The ribs can be of great thickness and genuinely serve to increase the structural rigidity of the bottom portion of the sump 100, and not only limit the acoustic effects.

Another benefit of the method lies in the ease with which a plastic sump, of optimized form and rendered highly structural, can be manufactured. It is in fact easy to obtain the two parts to be assembled. Furthermore, it is possible to modify just one of the two parts 30, 50 to produce a new form of sump. The form of the bottom 10 can thus be modified locally, for example, without requiring a complete replacement of the manufacturing installation. This method can be easily industrialized and is more particularly ideal for meeting the requirements of mass-production manufacture, unlike methods of molding complex and therefore costly parts. Furthermore, the use of a plastic material of small thickness and therefore of little weight offers a benefit in both economic and environmental terms.

It should be clear to those skilled in the art that the present invention allows for embodiments in numerous other specific forms without departing from the scope of the invention as claimed. In particular, although the description relates to an oil sump, it will be understood that any equivalent liquid, any lubricating substance, a liquid medium with evaporation point higher than water (therefore less volatile) and preferably not miscible with water, can also fill the bottom 10 of the sump 100.

1. A structural oil sump for a combustion engine, provided with a top opening and comprising:
a single-piece top part made of plastic material comprising a number of lateral walls peripherally delimiting an internal volume, and at least one transversal part extending inside said internal volume and joining at least two of the lateral walls, said top part extending between a top end defining said top opening and a bottom end defining a bottom opening;
a bottom part comprising a bottom and fixed in a sealed manner to the bottom end of the top part;
the sump being provided with internal ribs formed integrally with the top part and positioned opposite the bottom.

2. The structural oil sump of claim 1, wherein said bottom part is made of plastic material.

3. The structural oil sump of claim 1, wherein said transversal part is further away from said bottom than from the top end of the top part.

4. The structural oil sump of claim 1, wherein said transversal part is further away from the bottom end than from the top end of the top part.

5. The structural oil sump of claim 1, wherein said internal ribs comprise ribs integrally linked both to one of said lateral walls and to said transversal part.

6. The structural oil sump of claim 1, wherein said transversal part forms a bridge provided with orifices distant from the lateral walls to allow a circulation of oil.

7. The structural oil sump of claim 1, wherein said top part has an inverted U shape, respectively according to two mutually orthogonal vertical cross-sectional planes.

8. The structural oil sump of claim 1, wherein said bottom part offers an internal volume of which a portion has a section, perpendicularly to the heightwise direction of extension of said top part, greater than the section of the internal volume of the top part.

9. The structural oil sump of claim 1, wherein said bottom part is essentially made of plastic material and is secured by welding to the bottom end of the top part.

10. The structural oil sump of claim 9, wherein the welding extends continuously all around the bottom opening.

11. The structural oil sump of claim 1, also comprising a securing device for securing the bottom part to the top part.

12. The structural oil sump of claim 1, wherein said bottom part comprises, on at least one external face, one or more projecting fixing members formed with said bottom part.

13. The structural oil sump of claim 1, wherein said bottom part comprises a cavity for incorporating an oil treatment module in a housing situated inside the bulk volume delimited by the sump.

14. Method of manufacturing a structural oil sump for a combustion engine, comprising assembling two complementary parts, of which one is a bottom part comprising a bottom and the other a top part comprising a top end delimiting a first opening of the top part, said method further comprising:
producing a injection molding by injecting plastic material to provide, all in a single block, said top part with an integrated transversal part which extends inside an internal volume of the top part;
during said injection molding, forming, integrally with said transversal part, ribs projecting towards a second opening of the top part; and
during said assembling, fixing said bottom part to a bottom end of the top part, at a distance from said transversal part, to block off said second opening in a sealed manner.
